(19) United States
(12) Patent Application Publication
(10) Pub. No.: US 2002/0164978 A1
(43) Pub. Date: Nov. 7, 2002

(54) System and method for making telecommunication calls

(76) Inventors: Paul Andrew Moskowitz, Yorktown Heights, NY (US); Stephen J. Boies, Mahopac, NY (US); Samuel Dinkin, Austin, TX (US); Philip Shi-Lung Yu, Chappaqua, NY (US)

Correspondence Address: MORGAN & FINNAEGAN, L.L.P., 345 Park Avenue, New York, NY, 10154-0053, US

(21) Appl. No.: 09/846,830

(22) Filed: May 1, 2001

(51) Int. Cl. H04M 3/42

(52) U.S. Cl. 455/415; 455/414

(57) ABSTRACT

The system and method are directed to an improved calling procedure. In a preferred embodiment, instead of dialing telephone numbers, callers enter mnemonic, alphanumeric “phone addresses” (PA's). PA's may be entered using methods such as telephone keypad entry, keyboard entry, voice input, and handwriting input. A reference table, such as a database, lookup table, or the like, associates these phone addresses with actual telephone numbers. Accordingly, when caller enters a PA, the system connects the caller to the corresponding telephone number. In one embodiment, restrictions may be put into place whereby a caller must fulfill certain requirements, such as physical location or personal identity, to be connected to the corresponding telephone number. Additionally, in another embodiment, two or more parties may share the same PA. If a caller enters such a PA, the system acts in order to determine which of the parties who share that PA the caller wishes and/or is entitled to reach.

### BACKGROUND OF THE INVENTION

1. Field of the Invention

The present invention relates to the field of telecommunications, and more particularly, an improved calling procedure.

2. Background Information

Telephone numbers for North American domestic calling typically consist of seven digits plus a three digit area code. A string of seven seemingly random digits is difficult to remember, partly because there is no apparent logical connection between a called party and the string of digits that constitutes the party's telephone number. While strings of seemingly random digits with no apparent relevance to their associated party are difficult to remember, words and phrases logically associated with the party to call are relatively easy to recall.

One solution to this problem has been to make use of the alphabet characters listed on the keys of the telephone's keypad. This results in numbers such as 1-800-sosappl. This solution, however, is limited in scope for several reasons. Firstly, such a mnemonic must be exactly seven characters long, not more or less. Furthermore, the letters q and z are not available. These limitations severely limit the mnemonics that can be chosen, and means that most parties cannot get the mnemonic that they would ideally want since seven characters is often not enough to uniquely describe a person or a specific department within a company.

A further problem is that ambiguity arises because of the keypad encoding system. At first glance, a party might expect to be able to choose as a mnemonic, any combination of seven characters, each of which can be one of 34 characters (24 letters+10 numerals), that has not already been chosen by someone else. However, this is not the case. For example, “2”, “A”, “B”, and “C” all share the key corresponding to the numeral “2.” Thus, the system cannot distinguish between these four characters. A telephone effectively recognizes “2”, “A”, “B”, and “C” as all being the same character. Thus, a caller can only choose seven characters, each of which can be one of 10 actual/unique “buttons.” This affects real world choices of mnemonics. For example, suppose someone wanted the phone number “hotdogs.”The user would be prevented from taking this if someone had already taken “hotfogs.” Even though these mnemonics are alphabetically different, they map to the same keypad numbers: 468-3647. What is more, “hotdogs” would not be available if the telephone number 468-3647 is already assigned to a caller.

Another disadvantage of using mnemonic telephone numbers is that not all seven digit combinations in an area code could ever correspond to meaningful mnemonics. For example, some seven digit combinations, when considered in terms of the characters available for each letter, could never make phonetic or literal sense in English or other western languages. One example of this is 999-9997 in which, according to the keypad's labeling, 9 can be W, X, or Y and 7 can be P, R, or S. Hence, of all the phone numbers available, there are only a few of them could be potential mnemonics. It is further clear, therefore, that despite the obvious benefits of mnemonic telephone numbers, such a system results in many unused telephone numbers. The current system also requires telephone users to know the area code that the number is in and dial it before the mnemonic.

A person who has trouble remembering a telephone number or area code of a mnemonic may attempt to use directory assistance. However, this system also has drawbacks. Firstly, using directory assistance can be expensive. Secondly, it is time consuming as a user must answer a series of questions in order to get the number. Conventional directory assistance requires one to know not only the full name of the party that they wish to call, but often the city and street as well. Certain enhanced directory services advertise allowing a user to find a listing without knowing, for example, the name of the city or the full name of the business. However, enhanced directory services are often more expensive than conventional ones, and they are also time consuming in that they require the user to answer a series of questions as the operator or computer needs to collect information to use in searching the directory database. Thus, it is more expensive and time consuming to use than to direct dial using a number or mnemonic.

### SUMMARY OF THE INVENTION

The system and method are directed to an improved calling procedure. In a preferred embodiment, instead of dialing telephone numbers, callers enter mnemonic, alphanumeric “phone addresses” (PA's). PA's may be entered using methods such as telephone keypad entry, keyboard entry, voice input, and handwriting input. A reference table, such as a database, lookup table, or the like, associates these phone addresses with actual telephone numbers. Accordingly, when caller enters a PA, the system connects the caller to the corresponding telephone number. In one embodiment, restrictions may be put into place whereby a caller must fulfill certain requirements, such as physical location or personal identity, to be connected to the corresponding telephone number. Additionally, in another embodiment, two or more parties may share the same PA. If a caller enters such a PA, the system acts in order to determine which of the parties who share that PA the caller wishes and/or is entitled to reach.

### BRIEF DESCRIPTION OF THE DRAWINGS

FIG. 1 illustrates a conventional phone system with the addition of a phone address apparatus of the present invention.

FIG. 2 illustrates examples of decoders and converters of certain embodiments of the present invention.

FIG. 3 illustrates the functionality of the decoder unit of the phone address apparatus.

FIG. 4 illustrates the functionality of the decoding process of FIG. 3 in more detail when keypad or numeric keypad entry is used.

FIG. 5 illustrates the functionality of the converter unit of the phone address apparatus.

FIG. 6 illustrates the functionality of the ambiguity resolving process of FIG. 5 in more detail.

FIG. 7 illustrates an example of a reference table that is used in one embodiment of the present invention.

### DETAILED DESCRIPTION OF THE INVENTION

The system and method are directed to an improved calling procedure. In a preferred embodiment, instead of dialing telephone numbers, callers enter mnemonic, alphanumeric “phone addresses” (PA's). A reference table, such as a database, lookup table, or the like, associates these phone addresses with actual telephone numbers, along with their area codes and country codes as necessary. If the caller enters a PA that is numerically identical to a standard telephone number, the system will connect the caller to the party that corresponds to this telephone number.

In another embodiment, two or more parties may register the same PA. The system then considers such a PA to be “ambiguous.” If a caller enters an ambiguous PA, the system then resolves the ambiguity in order to determine which of the parties who share that PA the caller wishes to reach. For example, the system may make this determination by asking the caller questions, based on the identity of the caller (perhaps determined by voice sample), based on the present physical location of the caller, based on the telephone phone number from which the user is calling, and/or other parameters. In some cases, the resolution of ambiguity step might determine that the caller, for example because of his location and/or identity, is not entitled to be connected to any of the parties who have registered a particular PA. Thus, for a particular caller, a PA registered by two or more parties may map to no telephone numbers.

A PA need not necessarily map to more than one telephone number to be considered “ambiguous” by the system. A PA which maps to only one phone number may be considered to be ambiguous when it maps to its one phone number with restriction. A PA maps with restriction when the PA only connects a caller to a particular phone number when one or more conditions are met. An example is a PA that maps to one phone number, but with a restriction based on the identity of the caller wherein only certain callers entering the PA are connected to the corresponding phone number. In this example the system resolves the ambiguity by determining the identity of the caller. The system then determines if the caller should be connected to the corresponding telephone number.

The PA's are strings of numbers and letters of a length determined by the provider. In one embodiment, the maximum length of a PA is greater than seven characters. For example, the maximum length may be 32 characters.

The Calling System

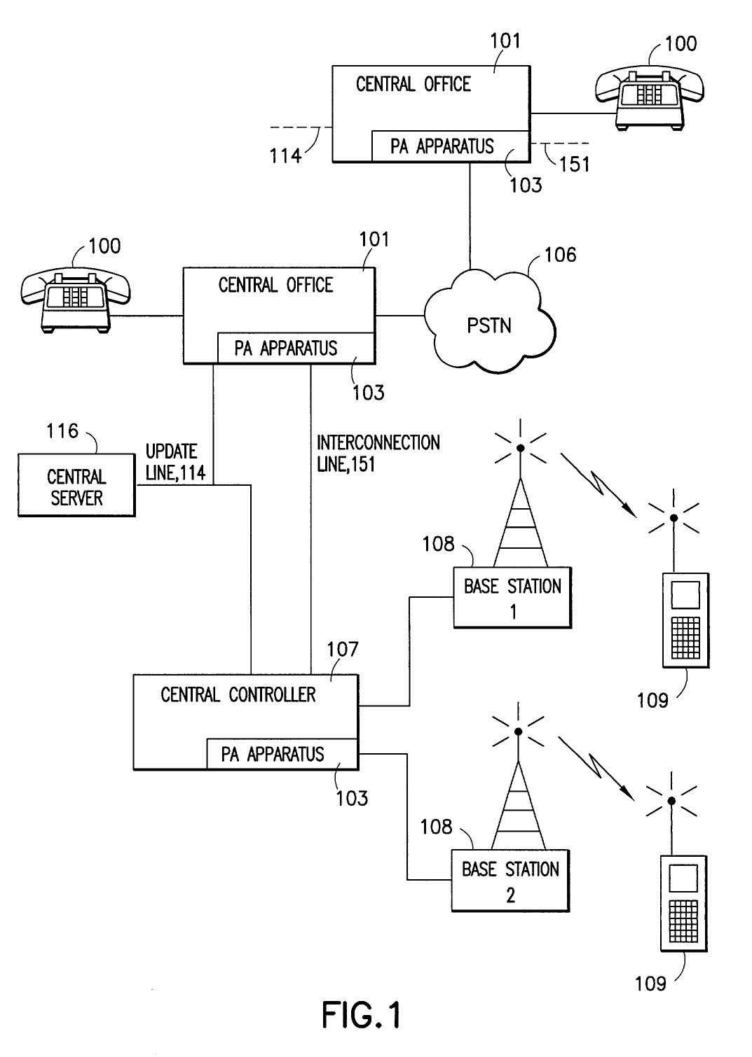

In FIG. 1, a conventional telephone 100 is connected to its local central office (CO) 101. The central office is connected to the public switched telephone network (PSTN) 106. Although one conventional telephone and one central office are shown for ease of description, there may be a plurality of CO's 101 connected to the PSTN, and a plurality of telephones connected to each CO 101. Further, although the network described is the PSTN, any network capable of handling calls using dialed characters may be used. Likewise, in addition to telephones, any device capable of completing calls using characters may be used.

Further shown in FIG. 1, a plurality of base stations 108 are connected to a central controller (CC) 107, which is in turn connected the local central office 101 via interconnection line 151. A plurality of mobile units 109 communicate with the base stations 108. Although one central controller is shown for ease of description, there may be a plurality of CC's 107 in the network, each connected to one of the plurality of CO's 101.

The CO 101 contains a digital switching apparatus, with a channel bank interfacing the analog telephone 100 with the digital switch. This central office further includes at least one PA apparatus 103. The PA apparatus 103 provides the functionality described wherein in which a caller may pick up his phone, enter a PA, and ultimately be connected to the appropriate party. The user may enter the phone address by speaking the phone address into the mouthpiece, typing it on an alphanumeric keyboard operationally attached to telephone 100, by typing it on the telephone's standard keypad/numeric keypad using the keypads alphanumeric labeling, or by similar methods. Other entry methods can be used as well, such as handwriting recognition. In one embodiment, a user does not enter an access code or dial an access number before entering a PA. In another embodiment the system could be configured so that a user would first call a gateway using standard dialing methods, and once connected to this gateway would enter the PA. In order to select among various communications providers, the user might enter a code before entering the PA. Alternately, the code might act as a lock-out password by which a person could not make calls without knowing the password.

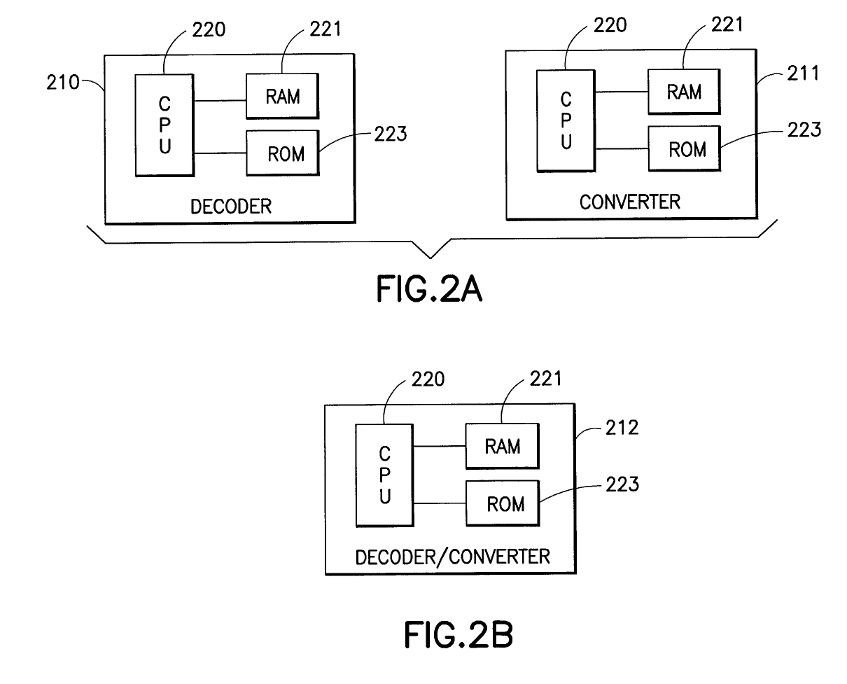

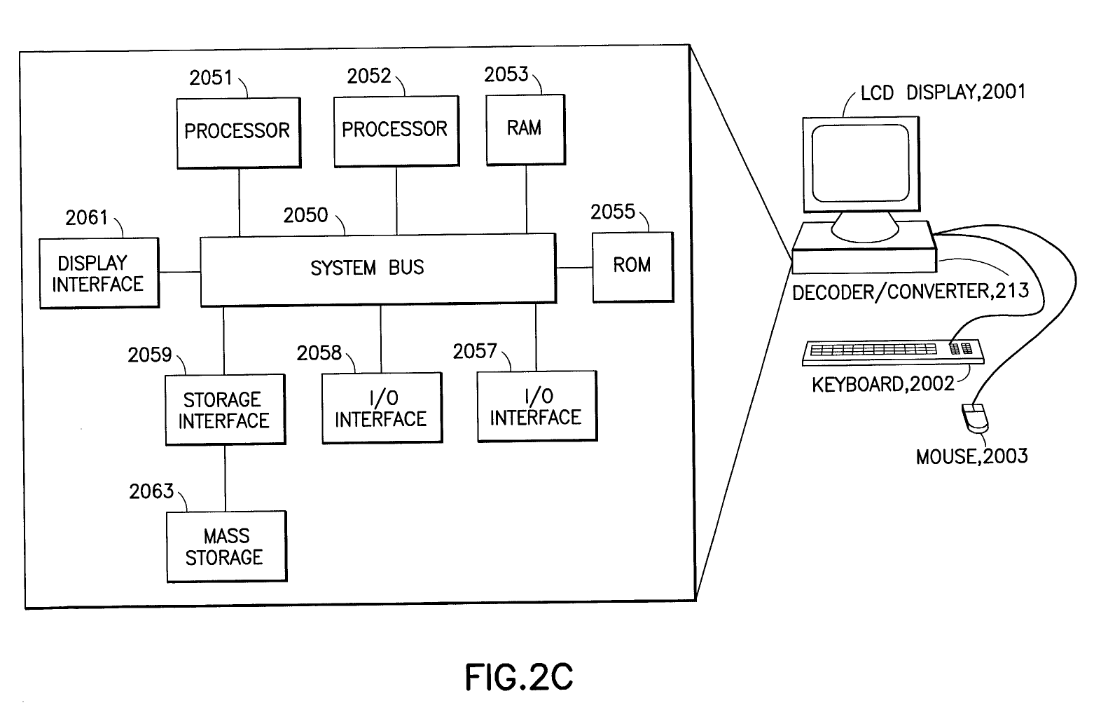

The PA apparatus 103 is made up of two logical units, a decoder and a converter. In practice, these two units may be either physically separate or combined into one unit. For example, FIG. 2a shows a decoder 210 and a converter 211 as two separate units. FIG. 2b shows a combined unit 212 which performs both decoding and conversion functions. In one embodiment, each of decoder 210, converter 211, and combined unit 212 contains read-only memory (ROM) 223 for holding data and program code which do not need to be changed frequently or on-the-fly, random access memory (RAM) 221 for holding data and program code which need to be changed frequently or on-the-fly, and one or more processors (CPU's) 220 operatively connected to the RAM and ROM whereby the processors may execute the program code and/or manipulate the code and/or data. CPU 220 may each be commonly known processor such as an IBM or Motorola PowerPC or an Intel Pentium. In one embodiment, decoding operations, converting operations, or both are performed by a general purpose computer 213 as shown in FIG. 2c which has been programmed to perform these operations as described herein.

The phrases “general purpose computer,” “computer,” and the like, as used herein, refer but are not limited to an engineering workstation, PC, Macintosh, PDA, web-enabled cellular phone and the like. The phrases “General purpose computer,” “computer,” and the like also refer, but are not limited to, one or more processors operatively connected to one or more memory or storage units, wherein the memory or storage may contain data, algorithms, and/or program code, and the processor or processors may execute the program code and/or manipulate the program code, data, and/or algorithms. Accordingly, computer 213 as shown in this example includes system bus 2050 which operatively connects two processors 2051 and 2052, random access memory (RAM) 2053, read-only memory (ROM) 2055, input output (I/O) interfaces 2057 and 2058, storage interface 2059, and display interface 2061. Storage interface 2059 in turn connects to mass storage 2063. Each of I/O interfaces 2057 and 2058 may be an Ethernet, IEEE 1394, IEEE 802.11, Signaling System 7 (SS7), or other interface such as is known in the art. Mass storage 2063 may be a hard drive, optical disk, or the like. Processors 2057 and 2058 may each be a commonly known processor such as an IBM or Motorola PowerPC or an Intel Pentium. Computer 213 may use an operating system known in the art such as Apple Computer's OS X, Microsoft's Windows 95/98/NT/Me, or a Unix variant or derivative such as Sun Microsystems's Solaris.

Computer 213 as shown in this example also includes an LCD display unit 2001, a keyboard 2002 and a mouse 2003. In alternate embodiments, keyboard 2002 and/or mouse 2003 might be replaced with a pen interface. Computer 213 may additionally include or be attached to card readers, DVD drives, or floppy disk drives whereby media containing program code may be inserted for the purpose of loading the code onto the computer.

Conventional telephone 100 connects to its local CO 101, which in turn notes the telephone number dialed and takes steps which culminate in the connection of the caller to the party indicated by the telephone number. The CO 101 shown in FIG. 1 additionally contains a PA apparatus 103. In the preferred embodiment, the user may enter the PA by speaking the phone address into the mouthpiece, typing it on an alphanumeric keyboard operationally attached to telephone 100, typing it on the standard tone keypad using the keypads alphanumeric labeling, or by similar methods. As will be described in more detail herein, the PA apparatus 103 then intercepts the entered PA, decodes it into a format ready for conversion, converts the decoded PA into the corresponding telephone number (obtaining additional information if necessary to solve an ambiguity), and outputs the phone number to the portions of the CO 101 that accept a phone number. The CO 101 then connects the call placed on phone 100 to the party indicated by the resolved phone number.

Similarly, the CC 107 operates in a manner similar to that of a conventional cellular central controller, but with the addition of the PA apparatus 103's functionality. A user may enter a phone address by speaking the phone address into the mouthpiece of a mobile 109, typing it on an alphanumeric keyboard operationally attached to mobile 109, typing it on the mobile's numeric keypad using the keypads alphanumeric labeling, or by similar methods. As will be described in more detail herein, the PA apparatus 103 then intercepts the entered PA, decodes it into a format ready for conversion, converts the decoded PA into the corresponding telephone number (obtaining additional information if necessary to solve an ambiguity), and outputs the phone number to the portions of the central controller that expect a phone number. The CO 101 then connects the call placed on mobile unit 109 to the party indicated by the resolved phone number.

The converter of 211, 212 or 213, uses a reference table, preferably stored in its RAM or in an attached hard drive, in order to convert a PA to a phone number. One or more central locations 116 contain master reference tables 700. An “update line” 114 allows the reference table 700 associated with the converter 211, 212 or 213 to be updated, according to a schedule, from one or more central locations 116, whereby the reference table associated with the converter will be a periodically updated copy of the master table. In one embodiment, additions and amendments may be made only to a master table, with the changes being propagated to the reference tables associated with the converters according to a schedule. The schedule may be set up such that updating occurs every so many units of time, whenever a change is made to the master table, or both. The updating may be achieved according to the conventional methods of replicated servers known in the art. Further, the master tables in the central locations 116 are preferably stored on replicated servers, wherein a change made to any is made to all, using the conventional methods of replicated servers known in the art. Update line 114 may provide connection to 116 via the internet, a dedicated T1 line, a satellite link, or by similar methods obvious to one well versed in the art.

Although the PA apparatus is shown here as being integrated into the central office or central controller, it will be obvious to one well-versed in the art that it may be placed at other logical locations within telephone system. For example, the PA apparatus 103 may be placed apart from, but functionally connected to, either the central office or the central controller. In some embodiments, this connection may include a Signaling System 7 (SS 7) interface as is known in the art. In another example, the PA apparatus might be piaced on a customer's premises, so that it interfaces between the customer's telephones and his interface to the telephone network. In a further alternate embodiment, the PA apparatus may be integrated into the telephone or the mobile unit.

Operation of the Decoder Unit

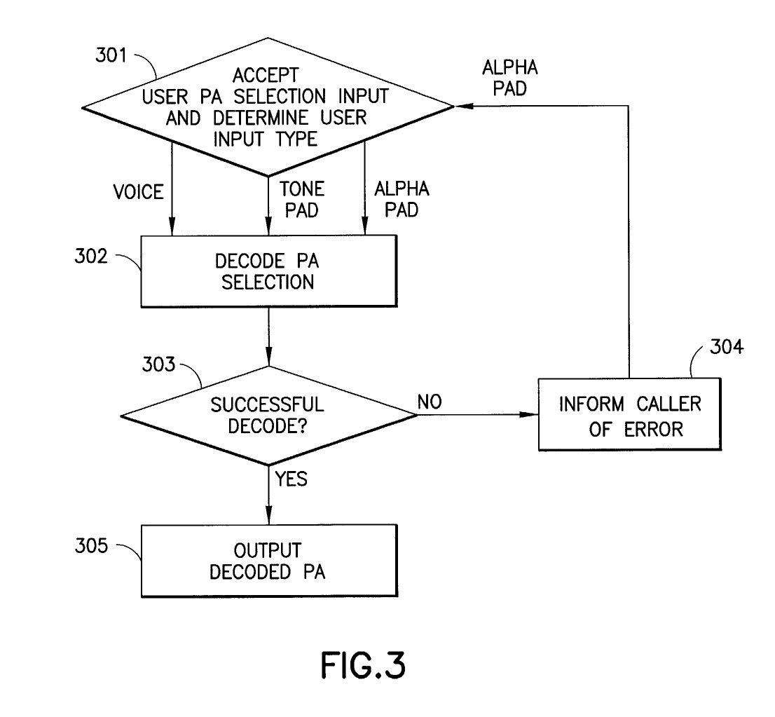

FIG. 3 is a flow chart showing the specifics of the operation of the decoder unit 210, 212 or 213.

In step 301, the decoder 210, 212 or 213 accepts the PA entry from the user, and determines the entry modality. In one embodiment, three entry modalities are used: voice, keypad, and alphanumeric keyboard. Other entry methods may also be used.

In step 302, the decoder 210, 212 or 213 decodes the PA entry into a format that the converter unit 211, 212 or 213 can understand. The decoding method will depend on whether the decoder 210, 212 or 213 determined the entry method to be voice, keypad, alphanumeric pad, or another entry method.

In step 303, the decoder 210, 212 or 213 determines if the decoding of step 302 is successful (i.e., if it was able to decode the PA entry). If it is not successful, the system proceeds to step 304 in which the caller is notified of the error and is prompted to re-enter the PA. In an alternate embodiment, instead of giving the caller an opportunity to re-enter the PA, the call may terminate. If the decoding step was successful, the process proceeds to step 305 in which the decoded PA is outputted to converter 211, 212 or 213. In some cases, this outputting step may involve transferring the decoded PA via Ethernet, IEEE 1394, IEEE 802.11, a common bus, or some other means connecting the decoder and converter. In other cases, this step may involve transferring the decoded PA between functions or objects of a program or programs running on the converter and/or decoder.

In the case of voice input, step 302 will execute one of the many speech recognition algorithms known in the art. For example, if ASCII text is the format the converter 211, 212 or 213 can understand, in step 302 the PA spoken by the user will be converted into ASCII text. In the case of alphanumeric keypad entry, the converter 211, 212, or 213 converts the data received from the keyboard into the format that is expected by the converter using conventional methods for reading keyboard input. For example if ASCII text is the format the converter 211, 212 or 213 can understand, the PA typed by the user will be converted into ASCII text using conventional methods.

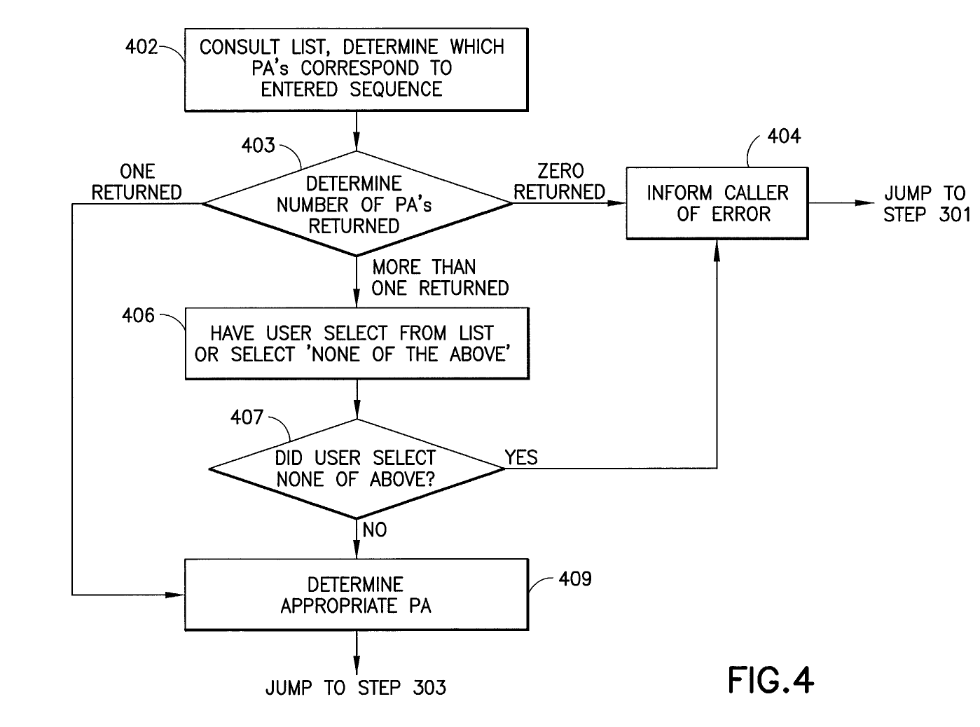

In the case of keypad or numeric keypad input, the converter 211, 212, or 213 converts the data received from the keyboard into ASCII text, or whatever input the converter receives. There are special considerations for the case of such pad input because of the ambiguity of the pad in which, for example, 5, J, K and L all share the same key such that when a user presses this key there is no way to know which of the four characters was meant by the user. The method for resolving this ambiguity in order to achieve step 302 for keypad PA input is described in FIG. 4.

Operation of the Decoder Unit: Resolution of Ambiguity

FIG. 4 discloses converter 211, 212 or 213's method for resolving the above-described keypad ambiguity when performing decoding step 302 for keypad PA input. In step 402 the decoder 210, 212 or 213 consults the reference table to see which preregistered PA's ambiguously correspond to the sequence of keypad presses. For example suppose the following keys were pressed:

[4 GHI] [2 ABC] [8 TUV] [3 DEF] [2 ABC] [6 MNO] [6 MNO] [7 PRS] [2 ABC] [6 MNO] [9 WXY]

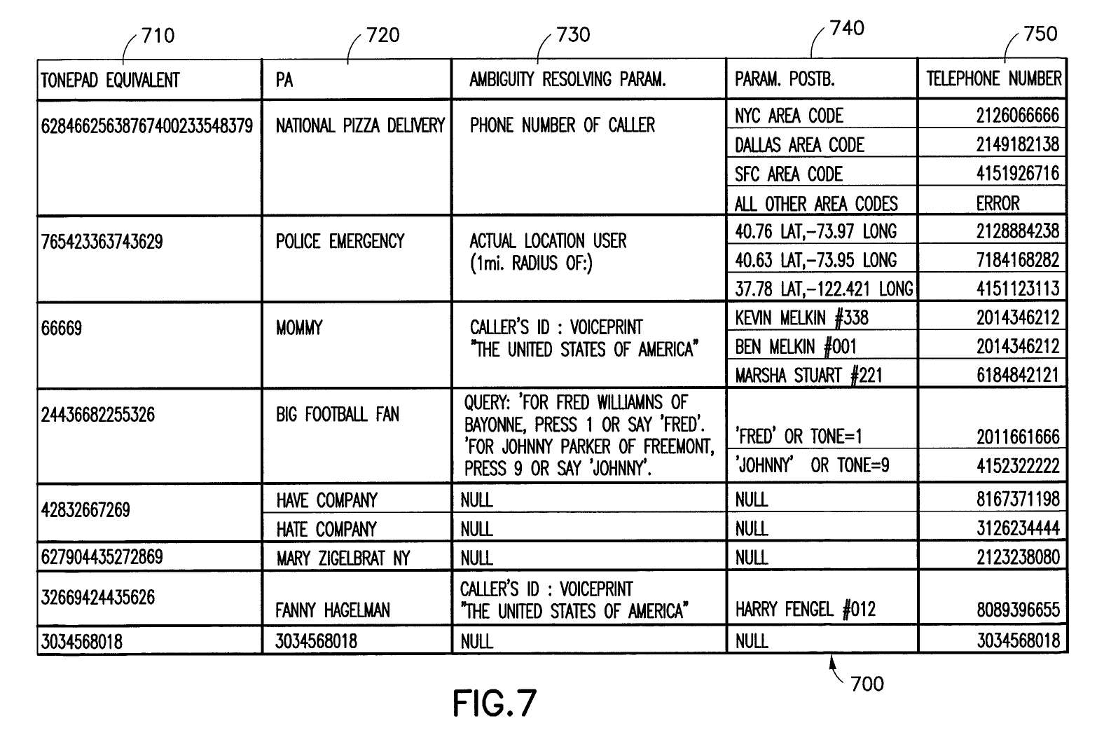

Referring to sample reference table (FIG. 7), the preregistered PA's HAVECOMPANY and HATECOMPANY, due to the keypad's ambiguity, could have been meant by the keys that were pressed. Although this example shows two preregistered PA's being returned for the particular keypad sequence, in real-world operation the reference table could show that none, one, or several PA's correspond to a particular keypad sequence. In step 403 converter 211, 212 or 213 determines how many PA's were returned at step 402. If no preregistered PA's were found to correspond to the keys pressed, the process proceeds to step 404 in which the caller is told of the error, and then to step 301, whereby the caller is given the opportunity to reenter the PA. In an alternate embodiment, the converter 211, 212 or 213 may terminate the call after telling the user of the error in step 404. If in step 403 the converter finds that step 402 resulted in only one match, the process proceeds to step 409. If the sequences of keypad presses is not unique, that is if the converter 211, 212 or 213 finds that step 402 resulted in a plurality of matches, the flow proceeds to step 406.

In step 406, the user is told to select the PA that he intended from the list of PA's that ambiguously correspond to the entered keypad sequence, or to choose “none of the above.”This could be done by the converter 211, 212 or 213 sending a message to a display screen operatively attached to telephone 100, using voice synthesis to output the message through the speaker or earpiece of telephone 100, or by other methods that are well known in the art. In one embodiment, the user will select his intended PA using the keypad. Thus, the converter 211, 212 or 213 might ask the user to “press 1 for ‘hate company,’ press 2 for ‘have company’, or press 3 for none of the above.”

In another embodiment, voice input may be used, such a method using a voice recognition method that is well known in the art. The user could be asked to “say 1 for ‘hate company’, say 2 for ‘have company’ or say 3 for ‘none of the above’.” The converter 211, 212 or 213 could use conventional voice-recognition methods to obtain the user's response.

In step 407 converter 211, 212 or 213 determines whether the user selected “none of the above.” In such a case, the system proceeds to step 404 in which the user is notified of the error and then to step 301, whereby the caller is given the opportunity to reenter the PA. In an alternate embodiment, the system may terminate the call after telling the user of the error in step 404. If the user does not select “none of the above,” the sequence will proceed to step 409 in which the reference table provides the PA corresponding the user's choice in step 406. The system then proceeds to step 303 of FIG. 3.

Operation of the Converter Unit

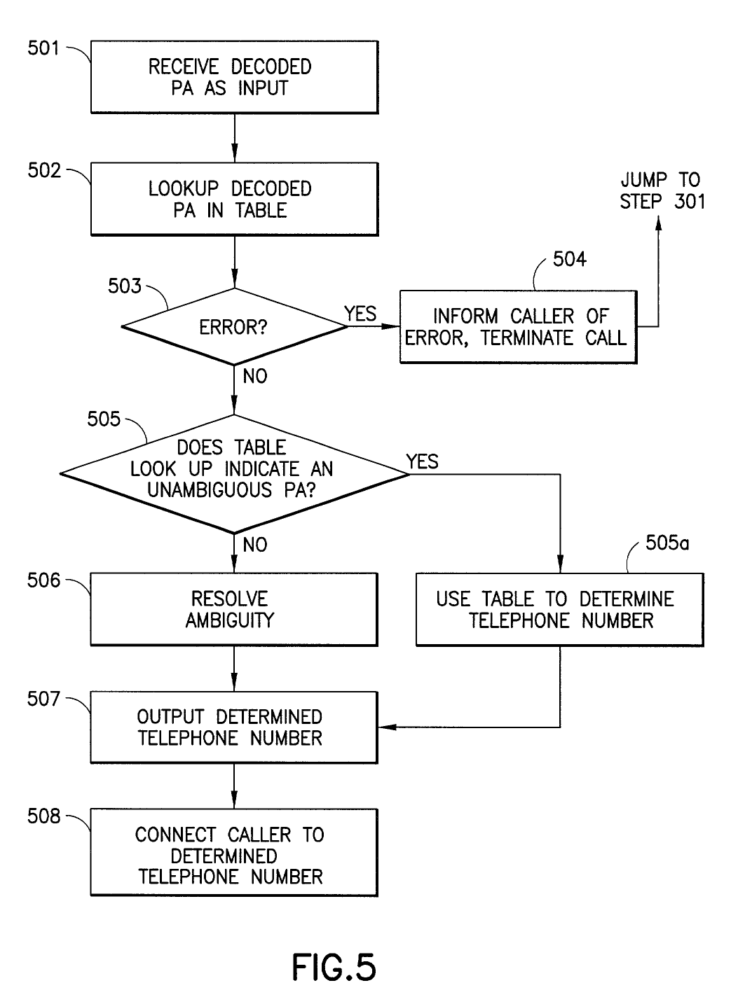

FIG. 5 is a flow chart illustrating the specifics of the operation of the converter unit 105. In step 501 the converter 211, 212 or 213 receives the decoded PA from decoder 104. In step 502, the converter looks up the decoded PA in the reference table. In step 503 the converter 211, 212 or 213 determines if the PA is listed in the table. If it is not, the sequence goes to step 504 where the user is told of the error, after which the sequence goes to step 301 where the caller may reenter the PA. In an alternate embodiment, after informing the caller of the error in step 504, the call ends. The system could also easy be extended such that if a user enters a PA that is not in the database, that the system would suggest a close match. For example, suppose both “IBM service” and “IBM sales” were preregistered PA's, but “IBM repairs” was not. If a user entered “IBM repairs” as a PA, the system might use conventional artificial intelligence (Al) to suggest “IBM service” but not “IBM sales.” Such functionality might be further extended so that the system could accept a freeform statement or query such as “My IBM PC is broken, and I need to fix it.” In response, the system would use conventional AI techniques to parse the statement for content, and with the retrieved content further use conventional AI to suggest the PA “IBM service.”

When no error is found in step 503, the sequence proceeds to step 505, where the converter 211, 212 or 213 determines whether the PA is ambiguous. When the PA is unambiguous, in other words when it maps to only one phone number and the PA owner has placed no restrictions on callers who can contact that corresponding phone number via the PA, the sequence proceeds to step 505a. In step 505a converter 211, 212, or 213 uses the reference table to determine a telephone number. After step 505a, flow proceeds to step 507.

In the case where the PA is ambiguous, in other words maps to two or more phone numbers or the PA maps to only one phone number but is restricted, the process passes to step 506 in order to resolve the ambiguity before passing to step 507. The details of ambiguity resolving step 506 are explained below. In step 507 the converter 211, 212 or 213 outputs the telephone number that, according to the reference table, corresponds to the entered PA. In step 508 the output is sent to the appropriate portions of the CO 101, CC 107, or the like so that the contact between the caller and the party associated with the entered PA can be established.

An example of an unambiguous PA can be seen in the sample reference table (FIG. 7) where we see that the PA “mary zigelbrat ny” maps only to the phone number 818-323-8080. On the other hand, the sample reference table notes that “police emergency” is ambiguous and maps to a plurality of phone numbers. In a case such as this it is up to the system to resolve the ambiguity in order to connect the caller to the proper police station

Operation of the Converter Unit: Resolution of Ambiguity

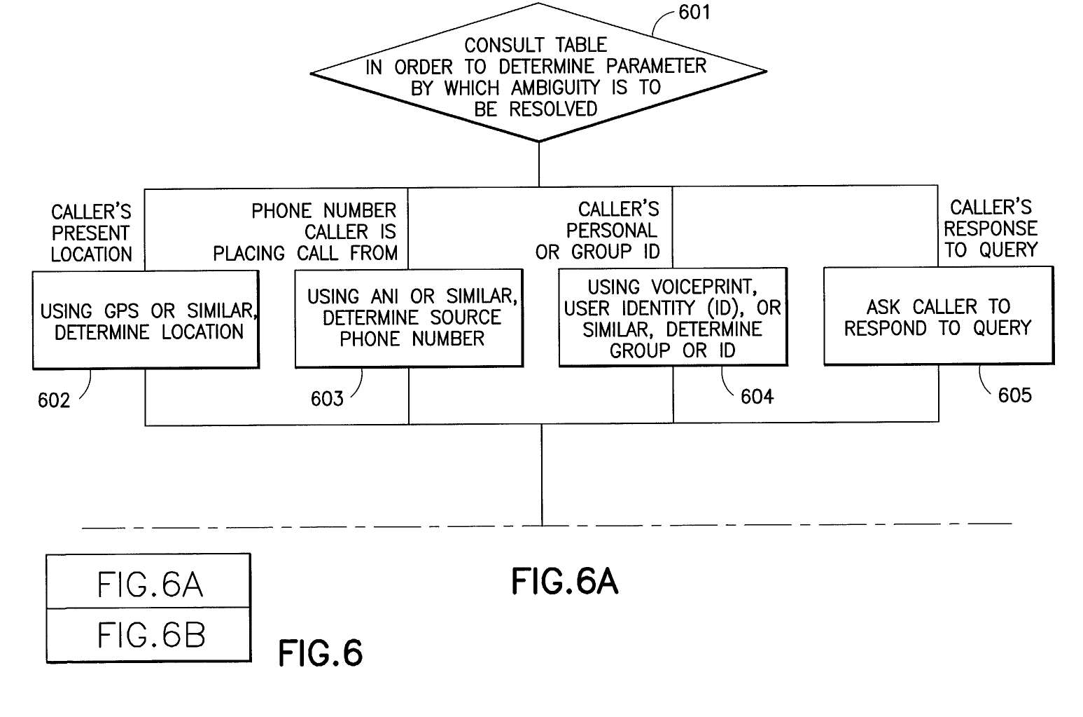

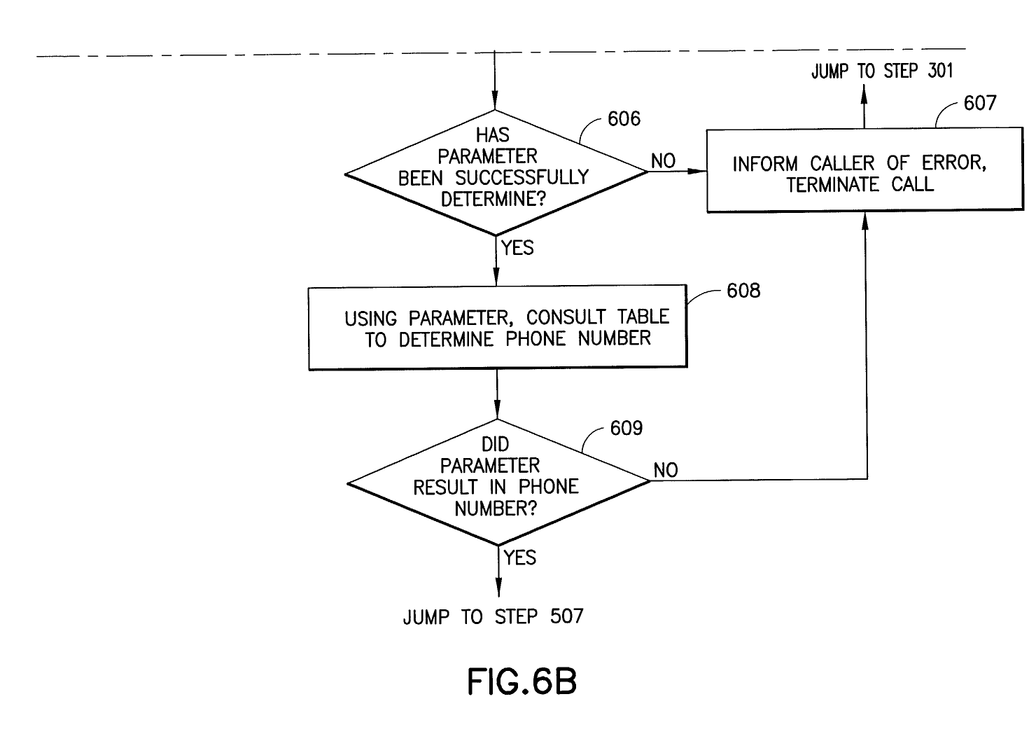

FIG. 6 is a flowchart detailing ambiguity resolving step 506. In step 601, the converter 211, 212 or 213 consults the reference table 700 in order to determine what parameter needs to be determined in order to resolve an ambiguity. In other words, it is determined what additional information needs to be gathered. Depending on the result of step 601, the system will proceed to one of steps 602, 603, 604, or 605.

If, in step 601, converter 211, 212 or 213 determines that the parameter is the caller's present location, the flow proceeds to step 602 where converter 211, 212 or 213 determines the current location of the caller (latitude/longitude coordinate). If in step 601 it is determined that the parameter to be the telephone number the call is being placed from, the flow proceeds to step 603 where converter 211, 212 or 213 determines the telephone number the call is being placed from. If it is determined in step 601 that the parameter is the caller's identity, the flow proceeds to step 604 where converter 211, 212 or 213 determines the identity of the caller. If it is determined in step 601 that the parameter is the caller's response to one or more queries, the flow proceeds to step 605 where the system asks the caller one or more questions provided by the table. In one embodiment, the user will answer such questions using the keypad or keyboard. In another embodiment voice input may be employed, using one of the voice recognition methods that are well known in the art. Steps similar to steps 602-605 may be added for embodiments in which additional parameters are used to resolve ambiguities.

In step 606 it is determined whether converter 211, 212 or 213 was able to successfully determine the necessary parameter. If not, the process proceeds to step 607 where the caller is informed of the error (e.g., by a voice or on-screen message), and then to step 301 where the caller may reenter the PA. In an alternate embodiment, after converter 211, 212 or 213 informs the caller of the error in step 607 the call ends.

If the necessary parameter has been successfully determined, the process goes to step 608. Here converter 211, 212 or 213 consults the reference table, in light of the entered parameter, to resolve the ambiguity and determine a phone number. In step 609 it is determined whether step 608 was successful (i.e., if the entered PA in light of the determined parameter resulted in a phone number) or unsuccessful (i.e., if the entered PA in light of the determined parameter did not result in a phone number). If step 608 was not successful, the process proceeds to step 607 where the converter 211, 212 or 213 informs the caller of the error, and then to step 301 where the caller may reenter the PA. In an alternate embodiment, after informing the caller of the error in step 607 the call ends. Step 608 might be unsuccessful, for example, if the caller, because of his location, phone number, group, identity (ID), or query answers, is not entitled to be connected to any of the parties who have registered the entered PA. If step 608 was successful, the flow proceeds to step 507 where the converter 211, 212 or 213 outputs the telephone number that, according to the reference table, corresponds to the entered PA.

The Reference Table

The use of the reference table rather than keypad encoding means that any PA mnemonic can be assigned to any telephone number. For example, unlike keypad encoding “hotdogs” and “hotfogs” could both be assigned as mnemonics. This is possible because the present system sees these as completely different mnemonics since they have different alphanumeric constructions. Further, whereas in the keypad encoding system “hotdogs” had to correspond to 468-3657, in the present system “hotdogs” may correspond to any available telephone number. Further “hotdogs” could be assigned as a PA, even if the PA “hotfogs” were assigned to a second party and the telephone number 468-3657 corresponded to a third party.

Phone addresses may be correlated with telephone numbers by the table in a variety of ways. In one embodiment, the system administrators may register (assign) “generic” PA's for users, and these users may choose additional “vanity” PA's for a fee. For example, when PA service comes to the neighborhood of Frank Jones of Upper West Side, Manhattan, he is assigned a first generic PA in the form of “frank jones upper west side,” and a second generic PA that is numerically equivalent to the telephone number he had been previously assigned. The table maps both PA's to his home phone number. For an extra fee, he may choose to register another phone address to either replace or augment his generic ones. For example, Mr. Jones may choose to register the phone address “big sports fan.” If he chooses “replace”, one or more of his two assigned PA's will be removed and only “big sports fan” and will map to his home phone. If he chooses “augment”, all three phone addresses will map to his telephone number. Alternately, as will be described in detail later, Mr. Jones may opt to have “deluxe unlisted” PA's, which are only valid under certain conditions. Further, a user may choose multiple PA's, perhaps with different features, which all map to the, same telephone number.

FIG. 7 is a sample reference table according to one embodiment. Column 710 of the table is the “keypad equivalent” column. It lists keypad/numeric keypad sequences which resolve to preregistered PA's. The column 720 of the table is the “PA” column which lists the preregistered PA's. It is related to the first column such that it notes for each keypad sequence the preregistered PA's that correlate to that keypad sequence.

The column 710 is only used for keypad or numeric keypad PA input. For example, if a keypad user entered “4283267269”, in step 402 the decoder 210, 212 or 213 can look up this keypad sequence in column 710 and learn from column 720 that the corresponding preregistered PA's are “have company” and “hate company.” The decoder would proceed to determine which PA was intended by the user. On the other hand, if the user entered “have company” using form of input other than keypad or numeric keypad, such as voice or keyboard, there would be no need to consult the column 710 in order to determine which PA was intended.

The column 730 is the “ambiguity resolving parameter” column. It is related to the column 720 such that it notes for each ambiguous PA what parameters resolve the ambiguity, and for each unambiguous PA a NULL value. The column 740 is the “parameter possibilities” column. For each entry in the “ambiguity resolving parameter” column, it notes the values of that parameter that are recognized by the system. For example, if the “ambiguity resolving parameter” column noted “actual location of user,” the “parameter possibilities” column would list specific location values for that parameter. When the PA is unambiguous, column 730 lists a NULL value for the PA.

The column 750 is the “telephone number” column. For unambiguous PA's, it is related to the column 720 such that it lists the telephone number that relates to an unambiguous PA of the column 720. For ambiguous PA's, it is related to the column 740 such that it lists the telephone number that relates to an ambiguous PA of the column 720 in light of a parameter value noted in the column 740.

The PA “mary zigelbrat ny” is an example of an unambiguous listing. Thus the ambiguity resolving parameter (ARP) column 730 states “NULL” to denote that there is no ambiguity to be resolved, as does the parameter possibilities (PP) column 740. The telephone number (TN) column 750 notes that the corresponding listing for “mary zigelbrat ny” is 212 323 8080. In addition to being an example of a unique listing, the listing for “mary zigelbrat ny” is also an example of a generically assigned PA as discussed earlier.

The PA “303 456 8018” is, in addition to being an example of an unambiguous PA, an example of one method by which the PA system can allow people in an area with PA service to call parties that live in an area that does not offer PA service. In this method, for each phone number in an area that is not served by PA service, a PA consisting of the numerals that make up the telephone number is listed to map to that phone number. For example, since the phone number 303-456-0818 is not served by PA service, the table lists a PA “303 456 0818” which maps to the phone number 303-456-0818.

A similar method can be used to allow users in a PA area to call a party using that party's phone number instead of that party's PA. The PA's “2123238080” and “mary zigelbrat, ny” both map to the telephone number 212-323-8080. Hence most users would probably contact the party using the easier-to-remember “mary zigelbrat, ny”, while those who were comfortable using her telephone number to contact her could continue to do so.

For ambiguous PA's, in some cases the resolution of the ambiguity will be “automatic” from the viewpoint of the caller, while in other cases it will be interactive. The PA “police emergency” is an example of an ambiguous listing where the resolution of the ambiguity is automatic. In this example, the corresponding ambiguity resolving parameter is the actual location of the caller. The PP column 740 notes several parameter values, and the TN column 750 notes the corresponding phone number for each parameter value. For example if the entered PA was “police emergency”, and the location of the caller was found to be “1 mi. radius of 40.76 Lat, −73.97 long,” the corresponding phone number would be 212 888-4238. The resolution is automatic because location data can be provided to the system from a GPS device in the caller's phone or mobile, and thus the system can learn the user's location without interacting with the user.

On the other hand, the PA “big football fan” is an example of an ambiguous listing where the resolution of the ambiguity is interactive, as converter 211, 212 or 213 must ask the caller questions in order to resolve the ambiguity. Consulting table 700, for this PA ARP column 730 lists “query caller . . . ”, further noting that converter 211, 212 or 213 should ask the user to “press 1 or say ‘fred’ if it's fred williams of Bayonne, press 2 or say ‘johnny’ if it's Johnny Parker of Freemont . . . . ” If, for example, the caller said “johnny”, converter 211, 212 or 213 consults PP and PN columns 740 and 750 of the table 700 and notes that when the parameter value is “johnny” the number is 415-232-2222. Although this example shows one question being asked of the caller, in practice one or more queries could be directed at the caller.

The listing of the PA “national metro pizza delivery” is another example of an ambiguous PA where the ambiguity can be resolved without consulting the caller. Referring to table 700, we see that the ARP column 730 tells the converter 211, 212 or 213 that the ambiguity is to be solved based on the phone number of the caller. The phone number of the caller is determined by using, for example, ANI (automatic number identification). If, for example, the caller's number is found to have a 212 area code, consulting the PP and PN columns 740 and 750 shows that the proper phone number is 212-606-6666.

The sample PA “mommy” is a case of an ambiguous PA where the ambiguity is resolved using the identity of the caller. Referring to table 700, for the PA “mommy” ARP column 730 discloses that voice sample identification is to be used, and that the voice sample of the caller is to be obtained by having the caller repeat the sentence “The United States Of America.” The converter 211, 212 or 213 then compares the voice sample of the caller with voice samples stored in a database so as to determine the identity of the caller. Looking at the PP and PN columns 740 and 750, if the identity of the caller is determined to be “Kevin Melkin #338”, then the appropriate phone number is 201-434-0212. On the other hand, if the caller is determined to be “Marsha Stuart #221”, the appropriate phone number is 618-484-2121.

In order to compile the voice sample database, users who plan on calling PA's that require voice authentication submit a voice sample to the system at a point prior to making the call. For example, such a sample could be given at a local phone company office where the identity of the person submitting the voice sample could be verified using a passport or other form of identification. In another embodiment, instead or in addition to using voiceprint authentication, the caller might be asked to enter an identification code and password. Further, handwriting recognition could be used as a means of confirming the ID of the caller instead or in addition to the above-described methods. In embodiments that use handwriting recognition for PA entry, the system could operate such that it would determine the identity of the caller based on the personally-identifying characteristics of the way in which the caller entered the PA. In other embodiments, the user might be asked to write a specific phrase such as “The United States of America.”

In step 609 of FIG. 6, if the value obtained for the parameter does not correspond to a telephone number, flow proceeds to step 607 where converter 211, 212 or 213 logs the error. For a PA like “mommy” this means that if the caller's voice sample does not match a voice sample on file, the person will not be connected to a party. Thus in addition to this method connecting a caller who enters “mommy” with the proper party, it also offers the security feature by which, for example, no one but Kevin and Ben can connect to 201-434-0212 by entering the PA “mommy.”

If the party who owns the telephone number 201-434-0212 further chooses to have no insecure PA's map to this phone number, and have the actual phone number be unlisted, a “standard secure” respectable level of security can be established in which the only people who can reach 201-434-0212 are those who enter the PA mommy with identities that were granted access by the owner of 201-434-0212, or parties from a non-PA service area who have somehow learned of the unlisted telephone number.

If, however, no insecure PA's map to this number, and people from non-PA service areas are prevented from reaching this number, then a high level of security, “deluxe unlisted/deluxe secure”, will be achieved in which the only people who can reach 201-434-0212 are those who enter the PA mommy and whose identities were granted access by the owner of 201-434-0212.

In a related embodiment, a user could order an “expiring listing PA.” For example, a professor can give out in class a PA that the table would map to his telephone number during the semester, but which would stop working after the semester ends. In some embodiments, the caller may hear “this PA has expired. There is no further information available.” When coupled with a deluxe unlisted PA for which none of his students has access privileges, or a standard unlisted PA that the students did not know, his students would not be able to reach him once the semester was done.

The features of “deluxe secure” and “standard secure” do not require a PA that maps to more than one phone number. As discussed previously, “ambiguous” PA's are not only those PA's which map to more than one phone number, but also those PA's that map to a single phone number but for which restrictions have been placed on what callers can use the PA to access the corresponding phone number. For example the PA “fanny hagelman” maps to only one phone number, but Ms. Hagelman has placed voice sample restrictions on who may use that PA to reach her. The PP column 740 for this PA denotes that only “Harry Fengel #12” may contact Ms. Hagelman using this PA; all other users entering PA “fanny hagelman” would be denied access.

In some embodiments, the system may be set up so that a user may set up aliases to commonly-entered PA's. Such aliases would be similar to aliases presently in use in computer file systems, email systems, and the like. For example, if a user calls the PA “Metro Pizza Delivery” often, he might choose to set up “my pizza” on his telephone as an alias to that PA. The user could subsequently enter “my pizza” to the same effect as entering the PA “metro pizza delivery.”

Although the description above contains many specificities, these should not be construed as limited the scope of the invention but as merely providing illustrations of some of the presently preferred embodiments of this invention. Thus it will be apparent to those skilled in the art that various modifications and variations cab be made in the system and processes of the present invention without departing from the spirit or scope of the invention. Accordingly, it is intended that the present invention cover its modifications and variations provided they come within the scope of the appended claims and their equivalents. In this context, equivalents means each and every implementation for carrying out the functions in the claims, even if not explicitly described herein.

What is claimed:

1) A method for connecting a user to a telephone number, comprising the steps of:
a) receiving a phone address entered by a caller;
b) determining the entry modality used by said caller to enter the received phone address;
c) decoding said received phone address according to the determined entry modality;
d) consulting a reference table using the decoded phone address, said reference table being periodically updated by a centralized master reference table; and
e) connecting the caller to the telephone number that results from said step of consulting the reference table.

2) The method of claim 1, wherein the decoded phone address is an ambiguous phone address.

3) The method of claim 2 wherein said step of consulting the reference table further includes consulting said table using additional information specified by an ambiguity resolving parameter, and wherein said step of connecting the caller is not performed if no telephone number results from said step of consulting.

4) The method of claim 1 wherein said reference table is a lookup table.

5) The method of claim 1 wherein said reference table is a database.

6) A system for connecting a user to a telephone number, comprising:
a memory having program code stored therein; and
a processor connected to said memory for carrying out instructions in accordance with stored program code;
wherein said program code, when executed by said processor, causes said processor to perform the steps of:
a) receiving a phone address entered by a caller;
b) determining the entry modality used by said caller to enter the received phone address;
c) decoding said received phone address according to the determined entry modality;
d) consulting a reference table using the decoded phone address, said reference table being periodically updated by a centralized master reference table; and
e) connecting the caller to the telephone number that results from said step of consulting the reference table.

7) The system of claim 6, wherein the decoded phone address is an ambiguous phone address

8) The system of claim 7 wherein said step of consulting the reference table further includes consulting said table using additional information specified by an ambiguity resolving parameter, and wherein said step of connecting the caller is not performed if no telephone number results from said step of consulting.

9) The system of claim 6 wherein said reference table is a lookup table.

10) The system of claim 6 wherein said reference table is a database.

11) A method for determining telephone numbers, comprising the steps of:
a) receiving from a caller an ambiguous phone address;
b) collecting the additional information specified by an ambiguity resolving parameter; and
c) determining, using said additional information, whether said phone address resolves to a telephone number.

12) A system for determining telephone numbers, comprising:
a memory having program code stored therein; and
a processor connected to said memory for carrying out instructions in accordance with stored program code;
wherein said program code, when executed by said processor, causes said processor to perform the steps of:
a) receiving from a caller an ambiguous phone address;
b) collecting the additional information specified by an ambiguity resolving parameter; and
c) determining, using said additional information, whether said phone address resolves to a telephone number.

13) The method of claim 11, further including the step of: connecting said caller to the telephone number which said phone address resolves to.

14) The system of claim 12, further including the step of:
connecting said caller to the telephone number which said phone address resolves to.

15) The method of claim 11, wherein said ambiguous phone address maps to a single telephone number.

16) The method of claim 11, wherein said ambiguous phone address maps to more than one telephone number.

17) The system of claim 12, wherein said ambiguous phone address maps to a single telephone number.

18) The system of claim 12, wherein said ambiguous phone address maps to more than one telephone number.

19) The system of claim 6, integrated into a central office.

20) The system of claim 6, integrated into a central controller.

21) The system of claim 6, integrated into a unit which interfaces between a telephone subscriber's telephone units and the subscriber's connection to a telephone network.

22) The method of claim 11, wherein said additional information is the caller's present location.

23) The method of claim 11, wherein said additional information is the telephone number the call is being placed from.

24) The method of claim 11, wherein said additional information is the identity of the caller.

25) The method of claim 11, wherein said additional information is the caller's response to one or more queries.

26) The system of claim 12, wherein said additional information is the caller's present location.

27) The system of claim 12, wherein said additional information is the telephone number the call is being placed from.

28) The system of claim 12, wherein said additional information is the identity of the caller.

29) The system of claim 12, wherein said additional information is the caller's response to one or more queries.

30) A method for determining a telephone number, comprising the steps of:
a) receiving a phone address; and
b) determining a telephone number correlated with the received phone address.

31) A system for determining a telephone number, comprising:
a memory having program code stored therein; and
a processor connected to said memory for carrying out instructions in accordance with stored program code;
wherein said program code, when executed by said processor, causes said processor to perform the steps of:
a) receiving a phone address; and
b) determining a telephone number correlated with the received phone address.
